(19) United States
(12) Patent Application Publication
(10) Pub. No.: US 2006/0278101 A1
(43) Pub. Date: Dec. 14, 2006

(54) Continuous method and system for producing wet cured ham

(75) Inventors: Prem Singh, Glen Ellyn, IL (US); Dejing Fu, Lisle, IL (US); James Costelloe, Naperville, IL (US); Gilbert L. Boldt, Naperville, IL (US)

Correspondence Address: Bingham McCutchen LLP;Suite 1800, Three Embarcadero Center, San Francisco, CA, 94111-4067, US

(73) Assignee: CONAGRA FOODS PACKAGED FOODS COMPANY, INC., Naperville, IL (US)

(21) Appl. No.: 11/138,159

(22) Filed: May 25, 2005

(51) Int. Cl. B02C 11/08

(52) U.S. Cl. 99/533

(57) ABSTRACT

A continuous method and system for processing and preparing a wet cured, ham in a continuous manner. Green hams are tumbled to at least partially loosen the fat and skin, which are trimmed into separate containers. A thin layer of fat remains on the hams. The trimmed fat and skin has not been exposed to a pickle solution and can be used or packaged for various purposes. A curing or pickle solution is injected into trimmed hams. The injected hams are held on a conveyor for a sufficient time to allow the rate at which curing solution drains from the injected hams to stabilize. During this time, pickle solution that drains from the hams is recovered and processed for subsequent use. The hams can be packaged in a net or bag and heated in a consistent manner since each ham has consistent quantities of curing solution.

### FIELD OF THE INVENTION

The present invention relates to processing meat products, and, more particularly, to a continuous method and system for processing hams.

### BACKGROUND

Ham products are staple food items in many parts of the world, including North America, Europe, Asia and Australia. According to the United States Department of Agriculture, a 3.4 ounce (100 gram) serving of roasted, extra-lean ham has about 145 calories, 5.5 grams of fat (5.5% fat), 21 grams of protein and relatively low cholesterol (53 milligrams). Ham products also include significant amounts of vitamins and minerals, such as vitamin B, zinc and iron. Thus, ham products are healthy alternatives to other meat products, such as beef, which may include higher levels of saturated fats and cholesterol.

Known methods and systems that are used to produce ham products, however, are typically time consuming and labor intensive which, in turn, increase production costs. Further, known methods and systems typically produce hams that retain and include different quantities of curing agent, such as a liquid pickle solution. These inconsistencies lead to inconsistent processing and quality.

For example, in one known process, hams are initially injected or pumped with a pickle solution, which may include, for example, salt, phosphates, sugar, sodium nitrite and desired flavorings (generally, “pickle” solution). The injected hams are held in storage bins and placed in a refrigerated environment or cooler. A typical storage bin may include 50 or more hams that are stacked on top of each other. A cover or bath of pickle solution is added to the bins so that the hams are immersed in the solution, allowing the pickle solution to soak into the hams. The injected hams are typically stored in the bins in a refrigerated environment overnight or for an extended duration, e.g., 8-24 hours. The hams are removed from the refrigerated environment, removed from the storage bins, and provided to a trimming station where fat and skin are removed from the hams.

Traditionally, it was believed that conventional “inject and hold” processes were beneficial since the skin and fat would retain a satisfactory amount of the injected pickle solution. Further, it was believed that holes formed through the skin by injection needles would be closed or sealed by the pliable skin to reduce the amount of pickle solution that was lost. It was also believed that holding injected hams for extended periods of time would allow the pickle solution to disperse consistently throughout the ham, and that the ham would be easier to trim after injection due to the injection needles puncturing the skin and fat.

However, known “stack and hold” processes have number of shortcomings and can be improved. Initially, “stack and hold” processes are time consuming. A significant amount of time is wasted due to the extended holding period in the refrigerated environment. Further, known processes are batch processes, which involve numerous interruptions, e.g., interruptions caused by transferring hams between injection stations and storage bins, transferring storage bins into and out of a refrigerated environment, removing hams from storage bins and transferring hams from storage bins to trimming stations. The required manpower and time that is required to process hams should be reduced.

Further, with known “stack and hold” processes, certain hams are subjected to different forces than other hams as a result of being stacked on top of each other in storage bins. More particularly, hams at the bottom of the stack are subjected to more weight than hams at the top of the stack. Consequently, hams at the bottom of the stack are compressed by the weight of the hams above which, in turn, causes more pickle solution drain from the bottom hams than the top hams. As a result, when the hams are removed from the storage bins, they have different quantities of pickle solution. When the batch of hams is cooked at a certain temperature for a certain time (e.g., in an oven or a smokehouse), the hams are cooked to different levels since the hams have different quantities of pickle solution. Further, the inconsistent quantities of pickle solution leads to inconsistent yields. Additionally, different quantities of ingredients may be required from lot to lot because of these cooking inconsistencies. These techniques unduly complicate processing and are inefficient.

A further shortcoming of known processes is that pickle solution that drains from the injected hams is wasted and/or not recycled. For example, in certain known systems, pickle solution drains from injected hams onto the floor and is subsequently discarded. Pickle solution is also dumped from the storage bins. Wasted pickle solution can increase production costs, and discarded pickle solution may reduce the effectiveness of wastewater treatment systems of ham production facilities.

Moreover, fat and skin that are typically trimmed from hams are trimmed after the hams are injected with pickle solution, and after the extended holding period in the storage bin. The trimmed fat and skin, therefore, contain pickle solution and are of diminished value and quality. Consequently, the pickle soaked fat and skin have limited applications. Trimmed fat and skin that include pickle solution are tolerated for some applications, e.g., rendering to recover the fat to be used in other food products. However, fat and skin trimmings that have not been exposed to pickle solution are more valuable and marketable than pickle soaked trimmings.

A need, therefore, exists for a process and a system that can produce hams in a continuous manner using process steps that prepare higher quality hams, while providing improved yields and improving process efficiencies. A need also exists for a continuous process and system that can recover pickle solution, and to provide fat and skin trimmings that are not exposed to pickle solution so that they can be used in other applications.

### SUMMARY

According to one embodiment of the invention, a system for processing hams that includes a trimmer, an injector and a conveyor. The trimmer, the injector and the conveyor cooperatively operate in a continuous manner. The trimmer removes fat and skin from green hams, and the injector inserts a curing solution into trimmed green hams. The injected hams are held on the conveyor for a pre-determined amount of time.

According to another embodiment of the invention, a system for processing hams includes a trimmer, an injector, a conveyor. The trimmer, the injector and the conveyor cooperatively operate in a continuous manner. The trimmer removes fat and skin from green hams. The injector inserts a curing solution into the trimmed green hams, and injected hams are held on the conveyor for a sufficient amount of time so that the rate at which the curing solution drains from the injected hams is substantially stabilized. At the end of the conveyor, each injected ham includes about the same amount of the curing solution after a portion of the injected curing solution drains from the injected hams.

In accordance with another alternative embodiment of the invention, a system for processing hams includes a trimmer, an injector and a conveyor. The trimmer, the injector and the conveyor cooperatively operate in a continuous manner. The trimmer removes fat and skin from green hams, and the injector inserts a curing solution into the trimmed green hams. Injected hams are held on the conveyor for about the same amount of time, e.g., about 15-60 minutes, to allow the rate at which curing solution drains from the injected hams to substantially stabilize. At the end of the conveyor, each injected ham includes about the same amount of curing solution.

In various embodiments, a system can include a tumbler that is positioned before the trimmer and that loosens the fat and skin of the green hams. The trimmer can remove substantially all of the fat from the green hams to leave a layer of fat having a consistent thickness, e.g., about ⅛″ to about ⅜″.

The conveyor that is used to hold injected hams can be a linear conveyor, a circular conveyor, a spiral conveyor or a helical conveyor, and the hold time can be about 15-60 minutes to allow thee drainage rate of curing solution to substantially stabilize. Thus, each injected ham includes about the same amount of curing solution at the end of the conveyor, e.g., each injected ham can retain about 30-80 wt. % of the injected curing solution.

In system embodiments, each injected ham is uncompressed, and no injected ham is stacked on top of another injected ham. Rather, each injected ham that is held on the conveyor is subjected to substantially the same vertical force.

System embodiments can include a container that is positioned below the conveyor. Curing solution that drains from injected hams held on the conveyor an be collected in the container. System embodiments can also include a packer that is positioned at the end of the conveyor and that is used to insert hams into a net or bag by the packer. The packer can cooperatively operate with the other system components in a continuous manner. System embodiments can further include a heater, e.g., an oven, that is positioned after the packer. The heater can cooperatively operate with the other system components in a continuous manner. The injected hams are partially or fully cooked in the heater and in a consistent manner since each injected ham includes about the same amount of curing solution.

### BRIEF DESCRIPTION OF THE DRAWINGS

Referring now to the drawings in which like reference numbers represent corresponding parts throughout:

FIG. 1A is a flow diagram illustrating a continuous method of processing hams;

FIG. 1B is a flow diagram that is a continuation of FIG. 1A, further illustrating a continuous method of processing hams;

FIG. 2 illustrates a system according to one embodiment that is used to process hams in a continuous manner according to one embodiment;

FIG. 3 illustrates a partial cross-sectional view of a known bone-in ham having bone, muscle, fat and skin;

FIG. 4 illustrates a partial cross-sectional view of a bone-in ham having skin and a portion of the fat removed from a desired portion of a ham, leaving a thin layer of fat around the muscle of the ham according to one embodiment;

FIG. 5A graphically illustrates improved retention of pickle solution within a ham according to one embodiment when the injected pickle solution is at a temperature of about 36° F.;

FIG. 5B graphically illustrates improved retention of pickle solution within a ham according to one embodiment when the injected pickle solution is at a temperature of about 46° F.;

FIG. 6 illustrates excessive losses of pickle solution from injected hams that are prepared using known processes that trim the hams unevenly;

FIG. 7 illustrates how embodiments of the invention retain greater quantities of pickle solution; and

FIG. 8 is a chart that illustrates the improvements of embodiments of the invention compared to known “stack and hold” ham processing methods and systems.

### DETAILED DESCRIPTION OF ILLUSTRATED EMBODIMENTS

In the following description, reference is made to the accompanying drawings which form a part hereof, and which show by way of illustration specific embodiments in which embodiments may be practiced. It is to be understood that structural changes may be made without departing from the scope of embodiments.

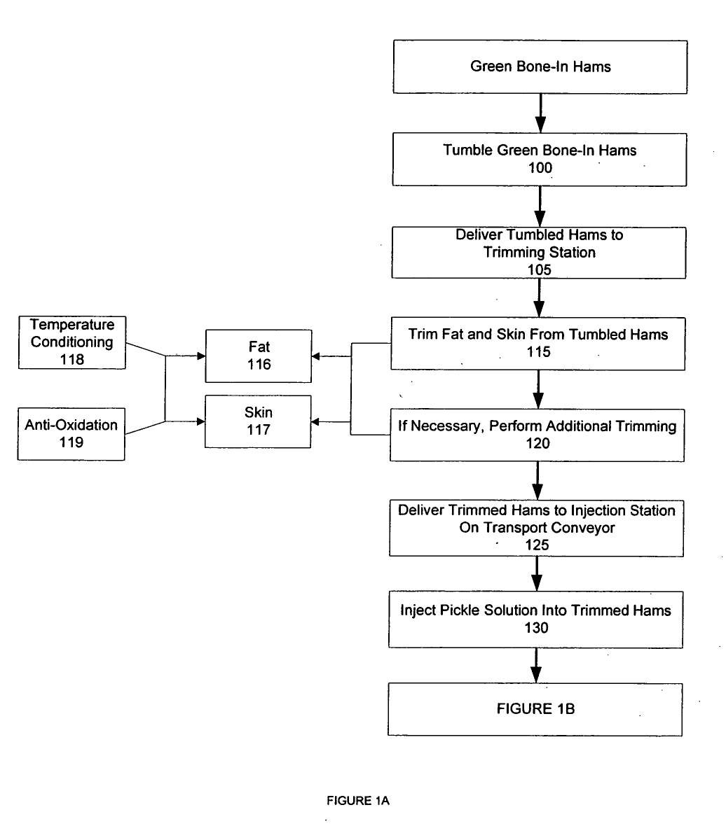

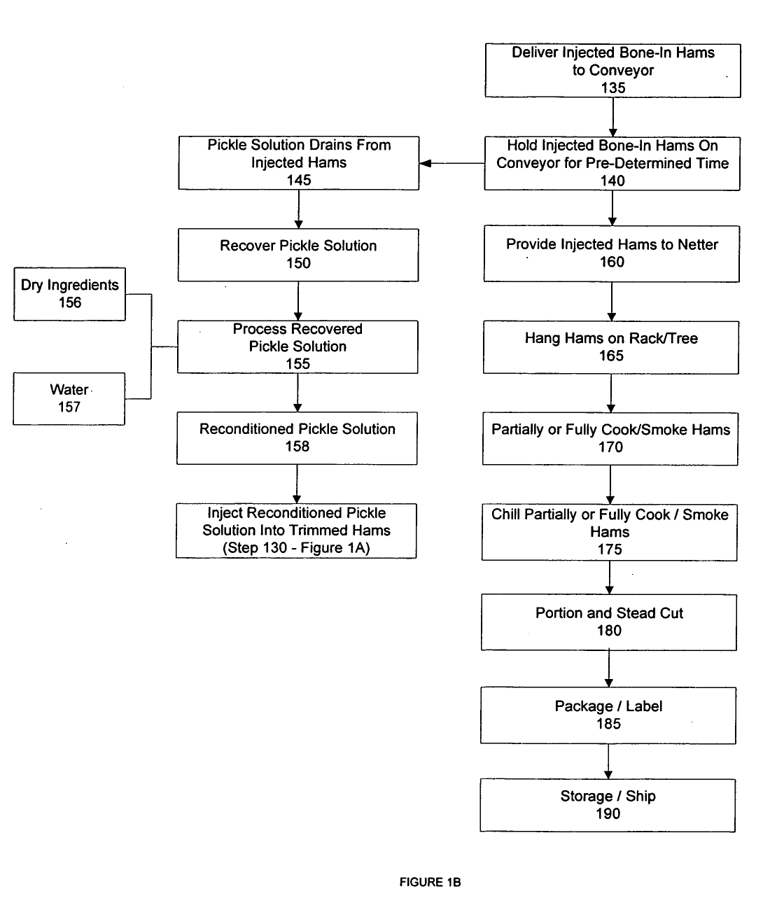

Referring to FIG. 1, embodiments provide methods and systems for producing wet cured hams in a continuous manner, without the interruptions that are associated with known processing methods. Embodiments can be used to process different cuts and portions of hams, including bone-in hams, and spiral, shank end half, butt end half, shank end portion, butt end portion, center cut sliced, steak sliced, half and whole hams and portions thereof. For purposes of explanation, not limitation, this specification refers to a “bone-in ham.” Persons skilled in the art will appreciate that embodiments can be applied to boneless cuts of ham and various cuts and portions thereof.

Initially, uncured or “green” hams are provided and tumbled in step 100. “Green” hams are known in the art and are hereby defined as an unprocessed and uncured ham, e.g, a ham that has not been injected with a pickle solution. Tumbling the green bone-in hams loosens the outer skin and fat layers. In addition, tumbling also conditions the outer surface of the hams. For example, tumbling can result in an outer surface of the ham having a uniform temperature. Tumbling can also make the outer surface more pliable so that it is easier to trim.

In step 105, tumbled green hams are placed on a transport conveyor. The transport conveyor delivers the tumbled green hams to a trimmer or trimming station.

In step 110, at the trimmer or trimming station (generally “trimmer”), skin and fat are removed from the green hams, which is facilitated by tumbling, which loosens the skin and fat. In one embodiment, trimming is performed automatically. Thus, the hams can be placed in trimming machines, and when trimming is completed, the trimmed hams are removed from the machines and placed on the same conveyor or a different transport conveyor to be delivered to an injector or injection station (generally “injector”).

In step 115, fat and skin trimmings 116 and 117 are collected. In step 120, if necessary, additional manual trimming may be performed as the hams are conveyed, e.g., using known wizard knives or trimmers.

In one embodiment, fat and skin trimmings 116 and 117 are simultaneously separated as they are removed from the green hams. The fat and skin trimmings can be collected in separate containers. When processed in this manner, the fat and skin trimmings do not contain pickle solution and are more desirable for use in other applications compared to pickle soaked trimmings. For example, trimmings that do not contain pickle solution can be used for other applications, such as making sausages, bologna and hot dogs and other food products to improve flavor and other organolyptic properties. Further, fat and skin trimmings that have not been exposed to pickle solution can be used to prepare pharmaceutical gelatin. Pickle soaked trimmings, on the other hand, may not be suitable for these types of products. Thus, embodiments of the invention advantageous over some known processes since fat and skin are trimmed from the hams before the hams are injected with pickle solution.

The fat and skin trimmings 116 and 117 can also be chilled or temperature conditioned 118 using, for example, known cryogenic and convective air chilling devices. The trimmings can also be treated with an anti-oxidant 119, such as Herbalox, to prevent chemical degradation of the trimmings.

In step 125, the trimmed and green hams are delivered by the transport conveyor to an injector. In step 130, the trimmed hams are injected or pumped with a pickle solution.

Referring to FIG. 1B, in step 135, the injected hams are provided to a holding conveyor. In step 140, the injected hams remain on the holding conveyor for a pre-determined amount of time. In one embodiment, the injected hams are held on the holding conveyor for a sufficient time to stabilize a rate of drainage of the liquid curing agent from the injected hams, e.g., about 30-60 minutes.

In step 145, pickle solution drains from the injected hams while the hams are held on the holding conveyor. In step 150, rather than allowing the pickle solution to fall onto the floor and be wasted (as in some known processes),embodiments recover the pickle solution that drains from the hams. According to one embodiment, pickle solution that drains from injected hams during the holding period is collected in a container positioned below the holding conveyor.

In step 155, if necessary, the recovered pickle solution can be reconditioned and used for subsequent injections. For example, the recovered pickle solution can be analyzed for salt content and other attributes. Pickle ingredients 156 and water 157 can be added to the recovered solution as necessary, so that the reconditioned solution 158 matches the fresh pickle solution. The reconditioned solution and/or a combination of the reconditioned and fresh pickle solutions can then be injected into green hams. Persons skilled in the art will appreciate that the pickle solution processing step can be performed at various times.

In step 160, the hams exit, fall from or are released from the holding conveyor and are provided directly to a netter or stuffer or packer (generally “netter”), or to another transport conveyor that leads to a netter. The netter places the hams in a net, a wrapping or a bag. The netting step can be performed using an automatic packager. For example, a netter can be configured to operate automatically using a roll-stock netting material rather than pre-cut and pre-clipped individual nets or bags. Alternatively, netting can be performed by manually inserting the hams into pre-cut and pre-clipped nets or a wrapping or bag.

In step 165, the netted hams are hung from racks. The hanging step can be performed automatically in conjunction with the automatic netting. Alternatively, hams can be hung on racks manually. In step 170, the netted hams are placed in an oven or smokehouse and partially or fully cooked and/or smoked. After cooking and/or smoking, in step 175, the hams are refrigerated or chilled in preparation for storage and/or distribution. In step 180, the chilled hams can be portioned and cut, and in steps 185 and 190, the hams are packaged, labeled and stored in preparation for shipment.

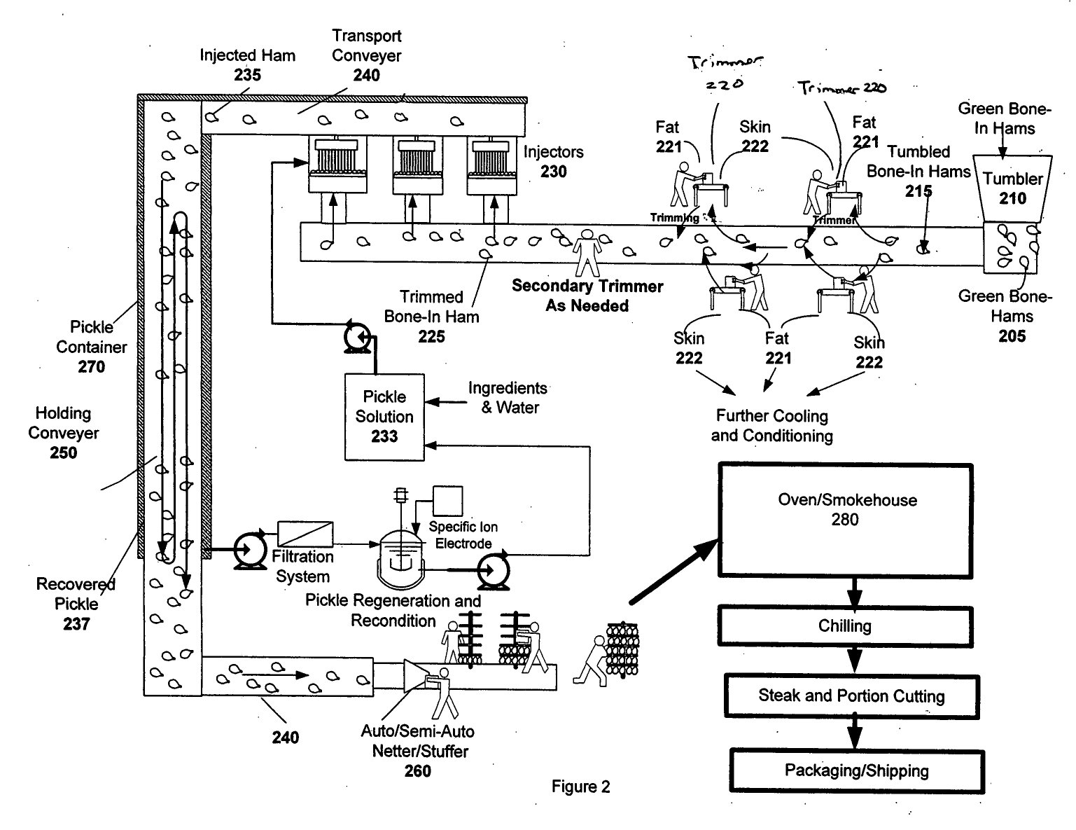

Various steps shown in FIGS. 1A and 1B can be performed in a continuous manner, as shown in the system illustrated in FIG. 2, so that embodiments of the invention eliminate unnecessary and time consuming steps and interruptions that are associated with known batch and “stack and hold” ham processing methods and systems. In particular, method embodiments do not inject hams first, then store injected hams in a refrigerated environment for an extended period of time (e.g., 8-24 hours), and then trim the hams. Rather, embodiments trim the hams before they are injected with a pickle solution, and then hold the injected hams on a conveyor for a substantially shorter time (e.g., 15-60 minutes) rather than 8-24 hours or overnight. Further, process embodiments eliminate the need to hold hams in storage bins and under a cover or bath of pickle solution, and the need to move hams in and out of the storage bins and back and forth between a refrigerated environment and other processing stations. Embodiments also recover and recondition pickle solution that drains from the hams held on the conveyor. Continuous ham processing is discussed and illustrated in further detail with reference to FIG. 2.

Referring to FIG. 2, a continuous ham processing system 200 includes one or more injectors 230, one or more transport conveyors 240 for moving hams between different stations, and a holding conveyor 250. The system can also include one or more trimmers 220, a tumbler 210 and a packer or stuffer 260. These components can be configured to cooperatively operate in a continuous manner, as shown in FIG. 2.

Initially, according to one embodiment green hams 205 are loaded into a tumbler 210 if the skin and fat of the hams are to be loosened prior to trimming. The temperature of the green hams when tumbled is preferably about 32-45° F. A transport conveyor 240 is positioned at the output of the tumbler 210. Green tumbled hams 215 exit the tumbler 210 onto a transport conveyor 240, which delivers the tumbled hams 215 to one or more trimmers 220. In the illustrated embodiment, four trimmers 220 are shown, two trimmers 220 on each side of the transport conveyor 240. Persons skilled in the art will appreciate that different numbers of trimmers 220 may be used as necessary.

One exemplary trimmer 220 that can be used is model no. 7600, available from Townsend Engineering, 2425 Hubbell Avenue, Des Moines, Iowa 50305. With this particular trimmer 220, a technician takes a ham from the transport conveyor 240 and positions the ham inside the trimmer 220. The trimmer 220 is activated and removes skin and fat from the ham. The trimmer 220 outputs the trimmed ham 225, which is placed on the same or another transport conveyor 240, which delivers the trimmed ham 225 to an injector 230. The fat 221 and skin 222 are trimmed and can be separated into separate containers. Other trimmers 220 may operate in an automated manner so that the ham is trimmed and output without technician assistance. Further, if necessary, hams that exit the trimmers 220 can be further manually trimmed using, for example, known “wizard” knives or trimmers, such as those available from Bettcher Industries, Inc., Vermilion, Ohio 44089.

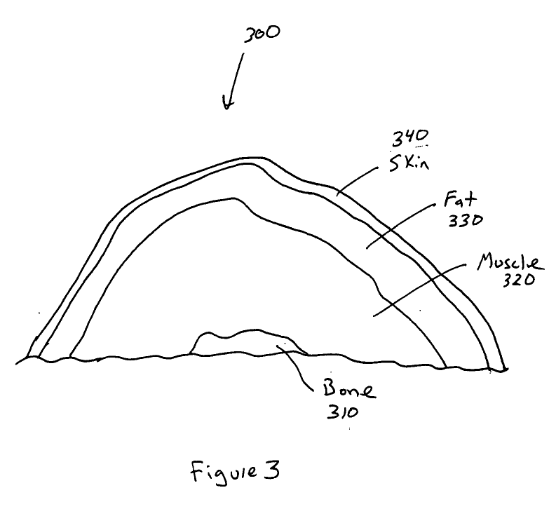

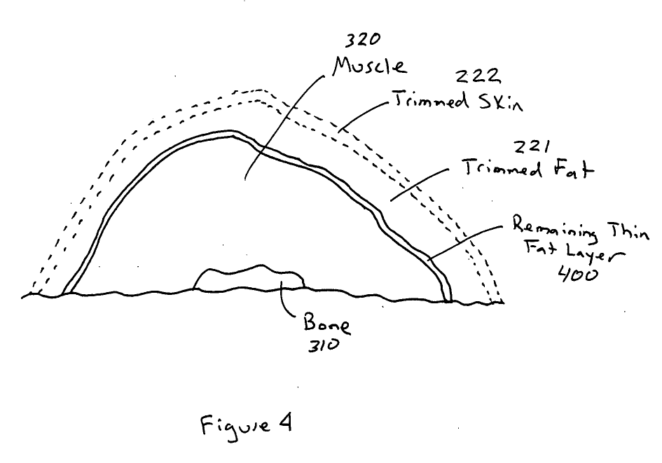

FIGS. 3-4 illustrate removal of skin and fat by the trimmers 220 in further detail. FIG. 3 is a representation of a partial cross-section of a typical bone-in ham 300, which includes bone 310, muscle 320, fat 330 surrounding the muscle, and skin 340. The thickness of the fat 330 can range from 1/16″ to about ½″, and the thickness of the skin 340 can range from about 3/32″ to about 3/16″.

FIG. 4 illustrates the effect of the trimmers 220, which remove fat 221 and skin 222 from the ham. It is not necessary for the trimmers 220 to remove all of the fat 330. Rather, as shown in FIG. 4, the trimmers 220 can be controlled to leave a thin layer of fat 400 on the ham (original skin 340 and fat 330 boundaries are shown as dotted lines). The remaining fat layer 400 can have a thickness of about 1/16″ to about ¼″. The fat layer 400 can have a uniform, consistent thickness. Further, the entire ham or substantially the entire body of the ham can have a thin, uniform layer of fat 400.

Referring again to FIG. 2, the fat and skin trimmings 221 and 222 generated by the trimmers 220 can be cooled or chilled and be conditioned as necessary. For example, the trimmings can be chilled to 35° F. to about 40° F. and treated with anti-oxidants, such as Herbalox, to prevent degradation of the trimmings.

Embodiments thus provide fat and skin trimmings 221 and 222 that are not exposed to pickle solution since the hams were trimmed prior to being injected with a pickle solution. Thus, the fat and skin trimmings are higher quality, more valuable and can be used for more purposes and products compared to pickle soaked fat and skin trimmings.

The trimmed hams 225 are carried by a transport conveyor 240 to injectors 230, which pump the hams 225 with pickle solution 233. Three injectors 230 are shown in FIG. 2 for purposes of illustration and explanation. Indeed, other numbers of injectors 230 may be used. Exemplary injectors 230 that can be used include various injectors available from Wolf-tec, Inc., 20 Kieper Lan, Kingston, N.Y. 12401. The injectors 230 can be used to insert an amount of pickle solution 233 that is, for example, about 50-100% of a weight of a ham. The overflow pickle solution from the injection process can be filtered using known screens or centrifuges.

The injected hams 235 exit the injectors 230 onto a transport conveyor 240, and are delivered to a holding conveyor 250. Alternatively, the injected hams 235 can be output directly onto a holding conveyor 250. Thus, FIG. 2, which shows a transport conveyor 240 between the injector 230 and the holding conveyor 250, is not intended to be limiting.

In the embodiment shown in FIG. 2, the holding conveyor 250 is a linear conveyor between the injectors 230 and a packer 260. The holding conveyor 250 can have various lengths, operate at various speeds and have various shapes. For example, in alternative embodiments, the holding conveyor 250 can be different shapes or be configured differently. A holding conveyor's 250 particular shape and size may depend on, for example, space and design considerations within a processing plant. For example, the holding conveyor 250 can also be a circular or spiral conveyor. A circular conveyor moves the hams in a circular manner and maintains the hams at a constant elevation. A spiral conveyor moves the hams in a circular manner and at different elevations. Persons skilled in the art will appreciate that other conveyor configurations may be used. so long a the desired hold time is achieved. Thus, embodiments of the invention are not limited to a particular holding conveyor configuration.

In one embodiment, the holding conveyor 250 has a length of about 300′ and moves the injected hams 235 thereon at a rate of about 10-15 feet/minute. As a result, the injected hams 235 are held on the conveyor 250 for a sufficient time to stabilize a rate of drainage of the pickle solution 237 from the injected hams 235, e.g., 15-60 minutes, preferably about 20-40 minutes. Persons skilled in the art will appreciate that other holding conveyor 250 speeds and lengths may be used so that an injected ham is held for about 15-60 minutes or other durations to stabilize pickle solution losses.

The pickle solution 237 that drains from the injected hams 235 and into a container 270 positioned below the holding conveyor 250 while the hams 235 are held on the holding conveyor 250. When using method and system embodiments of the invention, about 30-65% of the pickle solution 233 (by weight) that is injected into a ham may drain from each ham. Thus, each ham retains about 35%-70% of the injected pickle solution 233 (by weight).

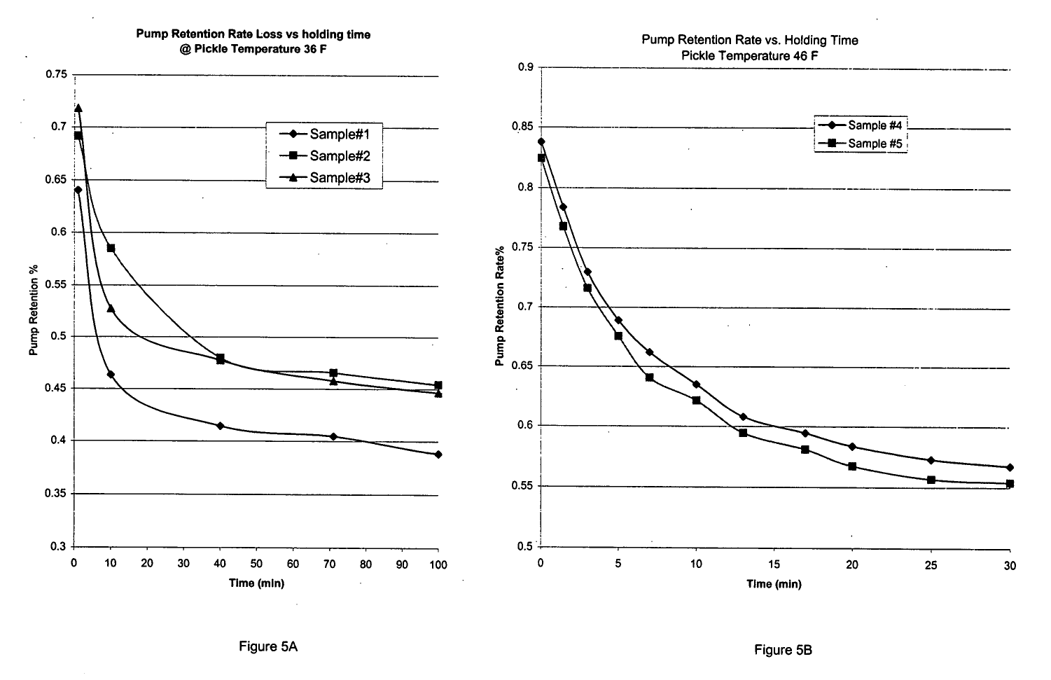

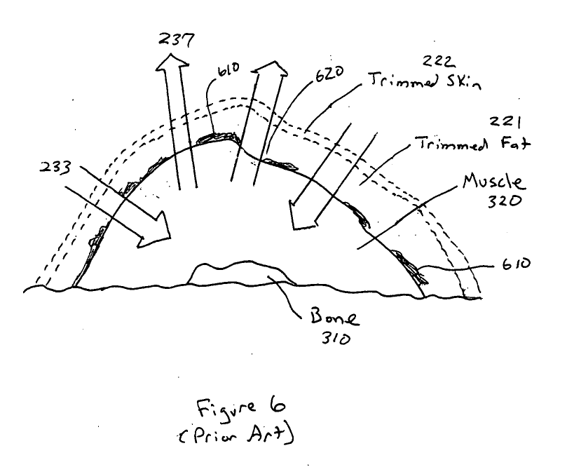

Referring to FIG. 4, a thin layer of fat 400 (FIG. 4) is useful to retain a larger amount of injected pickle solution that would otherwise drain from the injected hams. For example, FIGS. 5A and 5B are graphs that show the rate of drainage of pickle solution 233 from various injected hams.

FIG. 5A shows the results of three tests involving ham/sample #1, ham/sample #2 and ham/sample #3. These hams were injected with a pickle solution that was at a temperature of about 36° F. The amount of pickle solution that drained from each ham was measured over a holding time of 100 minutes, resulting in the chart showing the percentage of pickle solution that was injected and retained in each of the three over time. The graph shown in FIG. 5A illustrates that the rate at which pickle solution 233 drains from the injected hams 235 is highest between 0 and 10 minutes and slows between 10 and 20 minutes, and levels off by about 20-30 and through to 100 minutes. Thus, FIG. 5A shows that the hams can be held on a conveyor for a sufficient amount of time so that the rate at which the pickle solution drains from the injected hams is substantially stabilized. In these tests, the drainage rate is substantially stabilized beginning between 20-40 minutes, e.g., at about 30 minutes, after the hams were injected. FIG. 5B illustrates similar results when two hams (samples 4 and 5) were injected with a pickle solution that was at a temperature of about 46° F.

Compared to known systems and processes that inject hams, hold injected hams for extended durations, and then trim the hams, system and method embodiments reduce the amount of pickle solution that drains from the injected hams, thus increasing the yields of the final ham products. This result is achieved, in part, by the thin layer of fat 400 that is left on the ham following trimming, since the layer of fat 400 retains the pickle solution 233 inside the ham, rather than allowing it to drain through more porous muscle tissue.

For example, FIG. 6 illustrates a ham portion that was trimmed using known methods, which leave uneven or inconsistent layers or patches 610 of fat and cuts 620 into muscle tissue at 620. Consequently, pickle solution 233 that is injected into a ham having no fat or inconsistent small patches 610 of fat intermittently around the ham create conduits or holes 630 through which injected pickle solution can quickly drain from the hams since there is no barrier to retain the solution inside the ham.

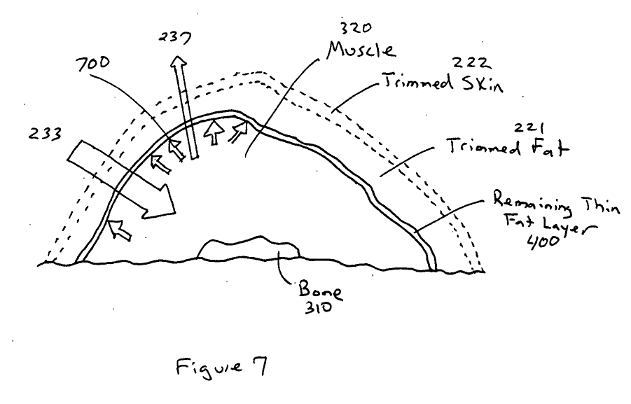

Referring to FIG. 7, when method and system embodiments of the invention are used, the green hams are trimmed, leaving a thin layer of fat 400 around the entire ham or around a substantial portion of the ham. As a result, when the ham is subsequently injected with pickle solution 233, the thin layer of fat 400 retains more of the pickle solution 700 inside the ham and reduces pickle solution losses 237, thus facilitating stabilization of the rate at which pickle solution drains from the ham within a short period of time (e.g., 20-40 minutes).

Referring to FIG. 2, the recovered pickle solution 237 can be processed or reconditioned so that it can be injected in other hams at a later time. Reconditioning may involve filtration and ion electrode treatment. Embodiments provide for recycling of pickle solution rather than allowing the pickle solution to be wasted and discarded, thus reducing the costs of processing hams and alleviating stress on wastewater treatment facilities.

Thus, system and process embodiments provide for initial trimming, injecting, holding and recovery of pickle solution to be performed continuously, without the interruptions that are normally associated with known processes and systems, which operate in a discontinuous manner and store injected hams in storage bins for extended periods of time. Moreover, embodiments provide for the amount of pickle solution 237 that drains from each ham to be consistent. Thus, it is not necessary to “over inject” hams to account for inconsistent pickle losses. As a result, with embodiments, less pickle solution can be injected into the hams, resulting in further cost savings.

After the holding period on the conveyor 250, the hams fall-from or exit the holding conveyor 250 and are placed on a transport conveyor 240, which leads to a netter 260 that inserts the hams into a netting, bag, or other packaging after the loss of pickle solution 237 has stabilized. In one embodiment, the netter 260 is an automatic netting mechanism that does not require a technician. Alternatively, netting mechanisms that require manual manipulation of the hams and/or netting can be used.

The packaged hams are then hung on a rack and partially or fully cooked in an oven 280. For example, the oven temperature may be about 140-185° F., and the hams may be cooked for about 10 hours. Each bone-in ham includes about the same quantity of injected pickle solution 233 and, therefore, all of the hams are cooked to a consistent level when heated at substantially the same temperature for substantially the same amount of time. After cooking, the hams can be cooled and prepared for shipping or storage.

As shown in FIG. 2, the trimming, injecting, holding, recovering and netting steps and system components can be coordinated so that they operate in a continuous manner using conveyors that transport hams between different stations without interruptions that are associated with known “stack and hold” systems and processes. Of course, persons skilled in the art will appreciate that continuous processing may involve maintenance interruptions, e.g., switching machines, loading pickle solution, etc.

A further advantage of embodiments is that the hams are each cooked to the same level when they are in the oven 280 because the hams have about the same quantity of pickle solution when they are cooked. More particularly, since the hams are held on the holding conveyor 250 and not piled on top of each other or compressed (as in some known systems), there are negligible inconsistencies (if any) in the amount of pickle in each ham. Each ham is uncompressed and subjected to the same vertical force (gravity). Thus, a consistent quantity of pickle solution 237 drains from each ham, thus providing consistent cooking results for a batch of hams that is placed in the oven.

Persons skilled in the art will appreciate that various modifications can be made to the system described above. The modifications may involve the number of transport conveyors 240, the arrangement of transport conveyors 240, the number of trimmers 230, the arrangement of the trimmers 230, and the shape and speed of the holding conveyor 250.

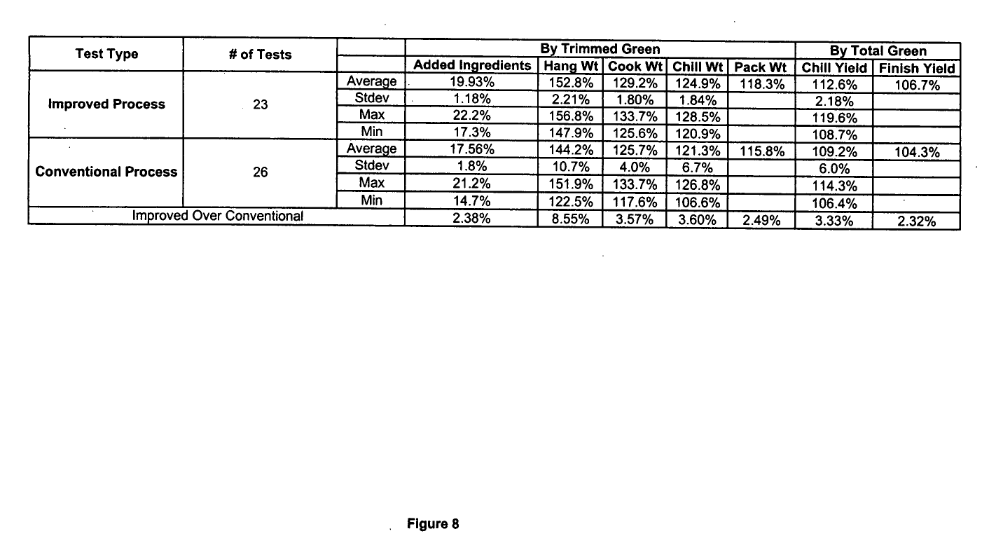

For example, FIG. 8 illustrates a system 800 according to another embodiment, which illustrates how system components can be arranged in different ways, but still provide continuous processing to eliminate interruptions that are associated with known systems and processes.

Considering the above, embodiments address shortcomings of prior art systems and methods. Embodiments provide higher quality hams having higher yields since greater quantities of pickle solution are retained in the hams due, in part, to the thin fat layer or membrane that is left on the ham after trimming. Further, consistent retention of pickle solution is achieved since embodiments do not stack or compress hams in storage bins, as in some known systems and methods.

Embodiments also eliminate the unnecessary interruptions and discontinuous operation of known systems resulting from movements of hams between storage bins and different pre-cooking processing stations, and the associated extended periods of holding hams in storage bins under pickle cover of conventional systems. Rather, embodiments operate in a continuous manner using interconnection transport conveyors that link or couple system components together and by maintaining hams on an integral holding conveyor while the pickle solution losses form the hams stabilize. Thus, system and method embodiments significantly improve processing efficiencies and reduce operating costs.

Embodiments also provide for recovering pickle solution that drains from injected hams that are being processed in a continuous manner, thus significantly reducing costs associated with the pickle solution.

Moreover, process and system embodiments allow pickle solution that drains from injected hams to be recovered and recycled for later use. Further, embodiments provide for trimmed skin and fat that have not been exposed to brine, thus increasing the value of these trimmings compared to skin and fat that is removed from hams that were previously injected with a brine solution.

Additional benefits include the ability to predict and control the ingredients that are added to the hams as a result of the consistent quantities of brine and cooking, which may not otherwise be possible with variances that may occur when using known systems and processes. For example, a consistent amount of ingredients, such as salt, phosphate, sugar, cure and water, can be added to each ham since each ham has a consistent amount of pickle solution and is cooked more consistently than hams prepared using known processes. In known processes, the amount of ingredients that are added may be excessive or deficient due to the inconsistent drainage of pickle solution and resulting inconsistent cooking.

FIG. 8 graphically illustrates the various benefits of embodiments of the invention. FIG. 8 is a chart that shows tests involving embodiments of the invention (improved process) and conventional processing techniques (as described in the Background). The chart includes “Added Ingredients,” “Hang Weight (Wt),” “Cook Weight (Wt),” Chill Weight (Wt), Pack Weight (Wt),” “Chill Yield,” and “Finish Yield” columns. The % values are percentages of the weight of the ham at a particular stage of processing.

Added Ingredients indicates data concerning the quantity of ingredients that are added to trimmed green hams after chilling. Hang Weight refers to the weight of the hams that are injected with a pickle solution after being released from the holding conveyor and netted and hanged. Cook Weight refers to the weight of the hams after being cooked. Chill Weight refers to the weight of the hams after cooking and after being chilled. Pack Weight refers to the weight of the finished/packed hams after chilling. Chill Yield is the weight of a cooked and chilled ham, expressed as a percentage of trimmed green weight. Finish Yield is the weight of a ham that is ready to be packaged, expressed as a percentage of trimmed green weight. The average value, standard deviation of the test values, maximum value and minimum values are provided, where appropriate, for each category of data.

As shown in FIG. 8, embodiments of the invention provide significant improvements over known processes and systems. For example, the hams [retained?] an average of 19.93 wt. % of added ingredients, whereas hams prepared using known processes retained only an average of 17.56 wt. % added ingredients. Thus, there was a 2.38 wt. % improvement in the amount of added ingredients retained by the hams using embodiments of the invention. Further, hams prepared according to embodiments had a Hang Weight of 152.8 wt. % (relative to green weight), whereas hams prepared using known processes had a Hang Weight of 144.2 wt. % (relative to green weight). Thus, there was a 8.55% improvement in Hang Weight with hams prepared using embodiments of the invention. Similar benefits are shown for Cook Weight, Chill Weight and Pack Weight. Hams prepared using embodiments of the invention posted respective 3.57 wt. %, 3.60 wt. % and 2.49 wt. % improvements in standard deviation of the amount of ingredients that were added to hams prepared with methods and systems according to embodiments of the invention was 1. The tests show that the improved process according to embodiments of the invention

Although references have been made in the foregoing description to various embodiments, persons skilled in the art will recognize that insubstantial modifications, alterations, and substitutions can be made to the described embodiments without departing from embodiments as recited in the accompanying claims.

What is claimed:

1. A system for processing hams, comprising:
a trimmer that removes fat and skin from green hams;
an injector that inserts a curing solution into the trimmed green hams; and
a conveyor, wherein the injected hams are held on the conveyor for a pre-determined amount of time, and wherein the trimmer, the injector and the conveyor cooperatively operate in a continuous manner.

2. The system of claim 1, further comprising a tumbler that is positioned before the trimmer and that loosens the fat and skin of the green hams.

3. The system of claim 1, wherein fat and skin are simultaneously removed from the green hams.

4. The system of claim 1, wherein the trimmer removes skin and substantially all of the fat from the green hams, thereby leaving a layer of fat having a consistent thickness.

5. The system of claim 4, wherein the layer of fat has a thickness of about ⅛″ to about ⅜″.

6. The system of claim 1, wherein the conveyor is a linear conveyor, a circular conveyor, a spiral conveyor or a helical conveyor.

7. The system of claim 1, wherein the injected hams are held on the conveyor for about 15-60 minutes.

8. The system of claim 1, wherein the injected hams are held on the conveyor for a sufficient amount of time so that the rate at which curing solution drains from the injected hams is substantially stabilized.

9. The system of claim 1, wherein each injected ham is uncompressed.

10. The system of claim 1, wherein no injected ham is stacked on top of another injected ham.

11. The system of claim 1, wherein each injected ham that is held on the conveyor is subjected to substantially the same vertical force.

12. The system of claim 1, further comprising a container positioned below the conveyor, wherein curing solution that drains from the injected hams held on the conveyor is collected in the container.

13. The system of claim 1, wherein each injected ham includes about the same amount of curing solution at the end of the conveyor.

14. The system of claim 1, wherein each injected ham retains about 30-80 wt. % of the injected curing solution.

15. The system of claim 1, further comprising a packer that is positioned at the end of the conveyor, wherein the injected hams are inserted into a net or bag by the packer.

16. The system of claim 15, wherein the trimmer, the injector, the conveyor and the packer cooperatively operate in a continuous manner.

17. The system of claim 15, further comprising a heater positioned after the packer, wherein the injected hams are partially or fully cooked in the heater.

18. The system of claim 17, wherein the trimmer, the injector, the conveyor, the packer and the heater cooperatively operate in a continuous manner.

19. The system of claim 17, wherein each injected ham includes about the same amount of curing solution, and wherein each injected ham is cooked to about the same level when heated for about the same amount of time at about the same temperature in the heater.

20. The system of claim 1, wherein the trimmer, injector and conveyor are in-line components that operate automatically without human intervention.

21. A system for processing hams, comprising:
a trimmer that removes fat and skin from green hams;
an injector that inserts a curing solution into the trimmed green hams; and
a conveyor, wherein the injected hams are held on the conveyor for a sufficient amount of time so that the rate at which the curing solution drains from the injected hams is substantially stabilized and, at the end of the conveyor, each injected ham includes about the same amount of the curing solution after a portion of the injected curing solution drains from the injected hams, and wherein the trimmer, the injector and the conveyor cooperatively operate in a continuous manner.

22. The system of claim 21, further comprising a tumbler that is positioned before the trimmer and that loosens the fat and skin of the green hams.

23. The system of claim 21, wherein fat and skin are simultaneously removed from the green hams.

24. The system of claim 21, wherein the trimmer removes skin and substantially all of the fat from the green hams, thereby leaving a layer of fat having a consistent thickness.

25. The system of claim 24, wherein the layer of fat has a thickness of about ⅛″ to about ⅜″.

26. The system of claim 21, wherein the conveyor is a linear conveyor, a circular conveyor, a spiral conveyor or a helical conveyor.

27. The system of claim 21, wherein the injected hams are held on the conveyor for about 15-60 minutes.

28. The system of claim 21, wherein each injected ham is uncompressed.

29. The system of claim 21, wherein no injected ham is stacked on top of another injected bone-in ham.

30. The system of claim 21, wherein each injected ham on the conveyor is subjected to substantially the same vertical force.

31. The system of claim 21, further comprising a container positioned below the conveyor, wherein curing solution that drains from the injected hams held on the conveyor is collected in the container.

32. The system of claim 21, wherein each injected ham includes about the same amount of the curing solution at the end of the conveyor.

33. The system of claim 21, wherein each injected ham retains about 30% to about 80% of the injected curing solution.

34. The system of claim 21, further comprising a packer positioned at the end of the conveyor, wherein the injected hams are inserted into a net or bag by the packer.

35. The system of claim 34, wherein the trimmer, the injector, the conveyor and the packer cooperatively operate in a continuous manner.

36. The system of claim 34, further comprising a heater positioned after the packer, wherein the injected hams are partially or fully cooked in the heater.

37. The system of claim 36, wherein the trimmer, the injector, the conveyor, the packer and the heater cooperatively operate in a continuous manner.

38. The system of claim 36, wherein each injected ham includes about the same amount of curing solution, and wherein each injected ham is cooked to about the same level when heated for about the same amount of time at about the same temperature.

39. The system of claim 21, wherein the trimmer, the injector and the conveyor are in-line components that operate automatically without human intervention.

40. A system for processing hams, comprising:
a trimmer that removes fat and skin from green hams;
an injector that inserts a curing solution into the trimmed, green hams; and
a conveyor, wherein the injected hams are held on the conveyor for about the same amount of time, wherein the holding time for each injected ham is between about 15 minutes and about 60 minutes to allow the rate at which curing solution drains from the injected hams to substantially stabilize and, at the end of the conveyor, each injected ham includes about the same amount of curing solution after a portion of the injected curing solution drains from the injected hams, and wherein the trimmer, the injector and the conveyor cooperatively operate in a continuous manner.

41. The system of claim 40, further comprising a tumbler that is positioned before the trimmer and that loosens the fat and skin of the green hams.

42. The system of claim 40, wherein fat and skin are simultaneously removed from the green hams.

43. The system of claim 40, wherein the trimmer removes skin and substantially all of the fat from the green hams, thereby leaving a layer of fat having a consistent thickness.

44. The system of claim 40, wherein the layer of fat has a thickness of about ⅛″ to about ⅜″.

45. The system of claim 40, wherein the conveyor is a linear conveyor, a circular conveyor, a spiral conveyor or a helical conveyor.

46. The system of claim 40, wherein each injected ham is uncompressed.

47. The system of claim 40, wherein no injected ham is stacked on top of another injected bone-in ham.

48. The system of claim 40, wherein each injected ham on the conveyor is subjected to substantially the same vertical force.

49. The system of claim 40, further comprising a container positioned below the conveyor, wherein curing solution that drains from the injected hams held on the conveyor is collected in the container.

50. The system of claim 40, wherein each injected ham retains about 30% to about 80% of the injected curing solution.

51. The system of claim 40, further comprising a packer positioned at the end of the conveyor, wherein an injected ham is inserted into a net or bag by the packer.

52. The system of claim 51, wherein the trimmer, the injector, the conveyor and the packer cooperatively operate in a continuous manner.

53. The system of claim 51, further comprising a heater positioned after the packer, wherein the injected hams are partially or fully cooked in the heater.

54. The system of claim 53, wherein the trimmer, the injector, the conveyor, the packer and the heater cooperatively operate in a continuous manner.

55. The system of claim 40, wherein the trimmer, injector and conveyor are in-line components that operate automatically without human intervention.
